(19) United States
(12) Patent Application Publication
(10) Pub. No.: US 2021/0129271 A1
(43) Pub. Date: May 6, 2021

(54) APPARATUS AND METHOD FOR PROCESSING A WORKPIECE BY LASER RADIATION

(71) Applicant: GFH GmbH, Deggendorf (DE)

(72) Inventor: Ludwig Süss, Regen (DE)

(73) Assignee: GFH GmbH, Deggendorf (DE)

(21) Appl. No.: 16/471,432

(22) PCT Filed: Dec. 7, 2017
(86) PCT No.: PCT/EP2017/081848

§ 371 Date: Jun. 19, 2019

(30) Foreign Application Priority Data
Dec. 19, 2016 (DE) 10 2016 124 742.1

(51) Int. Cl. B23K 26/38; B23K 26/03; B23K 26/08

(52) U.S. Cl. CPC B23K 26/38; B23K 26/0853; B23K 26/032

(57) ABSTRACT

The invention relates to a laser processing machine for removing material from a workpiece, comprising a first station, at which a laser processing tool is provided and at which the workpiece is processed by means of the laser processing tool, at least a second station, at which the workpiece is measured and/or processed, and a transport device for moving the workpiece between the first station and the second station, the transport device having at least two transport units which can be moved independently of one another in two different spatial directions (x, y) in such a way that the transport units can be moved past one another in a first spatial direction (x) along which the first and second stations (III, II) are arranged.

### FIELD

The invention relates to an apparatus and a method for processing, e.g. for drilling, cutting or removing material from a workpiece by means of laser radiation.

### BACKGROUND

Laser processing machines, such as laser cutting machines, are generally known. They have a laser processing tool which provides a high-energy laser radiation. If this high-energy laser radiation is applied to a workpiece to be processed, material is removed.

Laser processing machines are known, which also have a measuring station in order to process the workpiece on the basis of the measured values recorded at the measuring station. In particular, a sensor provided at the measuring station can be used to measure the position of the workpiece in space, which provides the basis for the subsequent processing of the workpiece.

A disadvantage of the laser processing machines that have become known so far is that laser processing by means of the laser processing tool only takes place over a relatively short period of time and the period of time in which a workpiece is fed and measured cannot be used for the processing of the workpiece.

### SUMMARY

Disclosed embodiments provide a laser processing machine which uses the laser processing tool causing the workpiece processing more effectively with regard to its operating time.

According to a first aspect, a laser processing machine for removing material from a workpiece is disclosed. The laser processing machine comprises at least a first station at which a laser processing tool is provided and at which the workpiece is processed by means of the laser processing tool. In addition, at least a second station is provided at which the workpiece is measured and/or processed. In particular, the second station can include a sensor which can be used to detect information, such as geometry, contour, elevation profile, at least one marker, or the like. The sensor can be e.g. an image-recording sensor, such as a camera. Alternatively or additionally, the second station can also have a tool designed for processing a workpiece. This tool can be a laser processing tool, a tool for machining workpieces or a tool for erosive workpiece processing (e.g. spark erosion). Furthermore, a transport device is provided for moving the workpiece between the first station and the second station. The transport device comprises at least two transport units which are movable independently of one another in two different spatial directions in such a way that the transport units are movable past each other in a first spatial direction along which the first and second stations are arranged. The transport device is preferably designed in such a way that the transport units are spaced apart from one another in a second spatial direction before they are moved past one another, so that the transport units can then be moved past one another in collision-free fashion by moving them in the first spatial direction. This also includes the case that the transport units are moved simultaneously in the first and second spatial directions.

This ensures that the transport units can alternately feed a workpiece to the first station including the laser processing tool and, in so doing, the further transport unit which is currently not located at the first station can effect e.g. the removal of the already processed workpiece and/or the feed of a new workpiece and the measurement/processing thereof at the second station. This significantly increases the throughput of the laser processing machine and thus the efficiency thereof.

In an embodiment, the transport device has a guide rail arrangement that extends in a second spatial direction which is transverse to the first spatial direction. At least two travel rails that can be moved independently of one another are provided on this guide rail arrangement. These travel rails are used to form travel paths for the transport units moving on them. The travel rails can be moved independently of one another along the second spatial direction to allow the transport units to move past one another in a collision-free fashion.

In an embodiment, in particular precisely one transport unit is guided on each travel rail and is movable in the first spatial direction extending transversely, in particular perpendicularly, to the second spatial direction. The travel rail thus forms a guide for the transport unit so that it can be moved along this travel rail. In particular, the travel rail forms a sliding guide for the transport unit.

In an embodiment, the travel rails are moved on the guide rail arrangement and/or the transport unit is moved on the respective travel rail by means of a linear direct drive. Linear direct drives are characterized by high positioning accuracy. The linear direct drives preferably have a positioning accuracy such that the workpiece can be positioned with an accuracy of less than 5 μm, in particular less than 1 μm, relative to the laser processing tool by moving the travel rails along the guide rail arrangement and moving the transport units on these travel rails.

In an embodiment, the first station and the second station are arranged in a common, vertically aligned machine plane. The laser processing machine is here designed in such a way that at least one travel rail is moved along the second spatial direction in order to move the transport units past one another. As a result, the transport units which, before being moved apart, have, at least some, overlapping sections along the first spatial direction (i.e. sections of the transport units lie in a common vertical machine plane), are moved apart in such a way that they can be moved past one another in collision-free fashion (i.e. the overlap is eliminated when they move apart).

In an embodiment, one travel rail or at least two travel rails are moved along the second spatial direction in such a way that, when the travel rails are moved apart, the distance is increased in order to be able to move the transport units past one another.

In an embodiment, the at least one travel rail is moved back along the second spatial direction after the transport units have moved past one another. This reduces the distance between the travel rails again and repositions the transport units, in particular the workpiece holders thereof, in the common, vertically aligned machine plane.

In an embodiment, the guide rail arrangement and/or the travel rails are temperature-stabilized. The temperature stabilization can be achieved in particular by a fluid transported in a circulating manner. Other variants of temperature stabilization (e.g. electrical) are also conceivable. This prevents, or at least significantly reduces, positioning inaccuracies caused by thermal expansion, which leads to higher processing accuracy.

In an embodiment, the drives for adjusting the travel rails and/or the drives for adjusting the transport units and/or the bearings of these drives are temperature-stabilized. The temperature stabilization can again be achieved, for example, by a fluid transported in circulating fashion. This allows the processing accuracy to be further improved.

In an embodiment, each transport unit has a workpiece holder which can be rotated and/or swiveled about at least two mutually orthogonal spatial axes. The workpiece holder can be designed in particular for holding the workpiece by clamping. The rotation or swiveling improves the variability of the processing operation. For example, oblique bores, etc., can thus be drilled into the workpiece.

In an embodiment, each transport unit has a workpiece holder and the transport units provided on different travel rails are arranged in such a way that the workpiece holders protrude from the respective travel rail on different sides, i.e. facing one another. As a result, the workpiece holders are arranged in the machine plane in which the processes carried out at the stations shall take place by positioning the travel rails accordingly.

In an embodiment, a third station is provided which is designed as a workpiece feed station. At this position, the workpieces to be processed can be fed either by machine or by hand. This can also be done using a robot, for example. Likewise, the workpieces can be turned at the third station in order to be able to carry out a rear processing of the workpiece after front processing.

In an embodiment, the second station (e.g. measuring station) is provided between the first station and the third station. Furthermore, the third station can be provided as an outer station. This means that a workpiece fed to the third station can be moved to the second station, while another workpiece at the processing station is processed by the laser processing tool, i.e. without having to interrupt the processing operation.

In an embodiment, the first station and the second station are arranged in such a way that the processing of the workpiece at the first station is carried out after moving the workpiece in the first spatial direction from the second station to the first station without a movement in a second spatial direction extending transversely to the first spatial direction. This further improves the processing accuracy since there are no positioning inaccuracies when positioning in the second spatial direction.

When moving past one another, a first transport unit is moved from the first station to the third station and a second transport unit is moved in the opposite direction from the second station to the first station in an embodiment. In other words, the transport units are moved past one another in the area between the first and second station. This means that the laser processing tool can be in mesh for as long as possible and at the same time a workpiece can be fed to the next transport unit or measured/pre-processed, etc.

In an embodiment, the second station is a measuring station with a sensor for recording workpiece information and the workpiece is processed at the first station on the basis of the workpiece information recorded at the measuring station. Thus, after the measurement of the workpiece, it is, for example, possible to remove material in an accurately positioned manner, e.g. to remove material so as to produce a hole.

In an embodiment, an optical unit is provided by means of which a laser radiation provided by a laser source is put into a wobbling motion. This allows positive or negative conical openings or recesses (e.g. also with undercuts) to be created in the workpiece.

In an embodiment, an apparatus for discharging a process gas is provided in the area of the processing station and is used to expel material evaporated by the laser radiation. The processing quality can be further increased by providing the process gas.

According to a further aspect, a method is disclosed for operating a laser processing machine, comprising at least a first station with a laser processing tool, a second station, and a transport device having at least two transport units for moving workpieces between the first and second station, the method comprising the steps of:
carrying out a processing step on a workpiece held on a first transport unit at the first station;
carrying out a measuring step and/or processing step on a workpiece held on a second transport unit at the second station;
moving the second transport unit past the first transport unit in such a way that the transport units are moved apart in a second spatial direction transverse to a machine plane in which the first and second stations are arranged and are moved parallel to this machine plane in order to position the first transport unit at the second station and/or the second transport unit at the first station.

The term “laser processing tool” as used herein refers in particular to a tool that provides high-energy laser radiation by means of which material is removed from a workpiece to be processed. The “laser processing tool” can have an optical system by means of which the laser radiation is bundled and/or focused.

The term “laser processing machine” as used herein refers in particular to a machine by means of which material is removed by laser radiation, e.g. laser drilling, laser cutting, laser turning or flat material removal, which merely removes material without creating an opening through the workpiece.

The expressions “approximately”, “substantially” or “about” as used herein mean deviations from the respectively exact value by +/−10%, preferably by +/−5% and/or deviations in the form of changes that are insignificant for the function.

Developments, advantages and possible applications also result from the following description of embodiments and from the drawings. All the features described and/or depicted may be used separately or in any combination, irrespective of their combination in the claims or their back-reference. The content of the claims is also made part of the description.

### BRIEF DESCRIPTION OF THE DRAWINGS

Disclosed embodiments are explained in more detail below by means of the drawings, wherein:

FIG. 1 shows, by way of example, an embodiment of a laser processing machine in a perspective view;

FIG. 2 shows, by way of example, the laser processing machine according to FIG. 1 in a lateral view;

FIG. 3 shows, by way of example, the laser processing machine according to FIGS. 1 and 2 in a top view; and

FIGS. 4a-4e show, by way of example, the schematic diagram of movement sequences of a transport device of the laser processing machine according to FIGS. 1 to 3.

### DETAILED DESCRIPTION

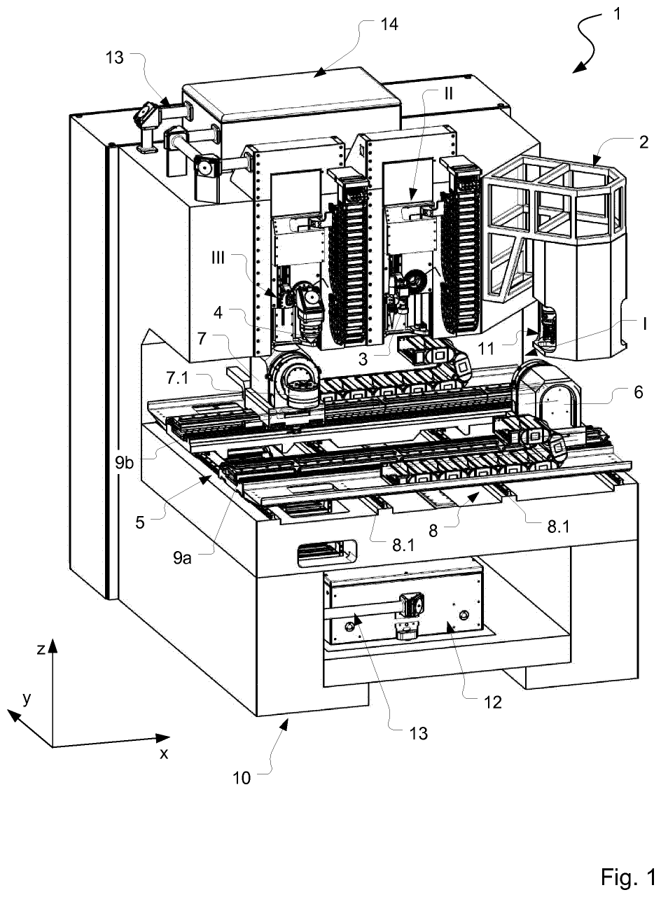

FIGS. 1 to 3 each show a laser processing machine 1 in different views. The following description of the laser processing machine 1 is based on a Cartesian coordinate system with perpendicular axes, namely an x-axis, a y-axis and a z-axis. In the embodiment shown, the laser processing machine 1 comprises a first station as processing station III, a second station as measuring station II and a third station as workpiece feed station I. It is understood that this machine configuration is purely exemplary and that other configurations are also contemplated, e.g. a machine with only two stations or a machine in which the second station is intended as an additional processing station. It is also understood that a sensor can be provided next to the processing tool at a processing station in order to be able to carry out a desired positioning or repositioning of the workpiece.

The workpiece feed station I is designed to feed workpieces to be processed in a suitable manner. For this purpose, a workpiece feed unit 2 is provided at this workpiece feed station I. In addition, the workpiece feed station I can also be used for workpiece removal, i.e. for the removal of workpieces that have already been processed. Furthermore, the workpiece feed station I can be used to turn the workpiece so that, for example, after an upper processing step, the workpiece can then be processed on the underside.

The measuring station II has a sensor 3, by means of which the workpiece to be processed is measured before it is processed. The sensor 3 can be a camera or a topography sensor, for example. The sensor 3 can be used in particular to record the local position of the workpiece in space, its contour, its elevation profile and/or a specific identification mark. Based on this data, the workpiece can then be processed at the processing station III. Particularly in the high-precision processing of workpieces in the micrometer or sub-micrometer range, such a measurement of the workpiece is necessary before it can be processed.

The processing station III has a laser processing tool 4, which provides a bundled laser beam. The laser processing tool 4 is especially designed to provide a pulsed laser beam with a pulse duration of less than 100 ns (short pulse laser) and especially less than 1 ps (ultra-short pulse laser). In particular, the laser processing tool 4 can be designed in such a way that the material of the workpiece passes directly from the solid to the gaseous state of aggregation by sublimation and thereby evaporates. This ensures high-precision material processing. Furthermore, a sensor can be provided at the processing station III, by means of which features can be detected on the workpiece or on a workpiece holder 6.1, 7.1 of a transport unit 6, 7. This sensor can be used e.g. to determine the position of the workpiece to control a rotary or swivel movement of the workpiece holder 6.1, 7.1.

As shown in FIGS. 1 to 3, the material feed station I, the measuring station II and the processing station III are provided in a common vertical machine plane ME, which is drawn by the x-axis and the z-axis. The workpiece feed station I, the measuring station II and the processing station III are arranged at a distance from one another in the x-direction.

A transport device 5 is provided for transporting the workpieces to be processed from the workpiece feed station I to the further stations and back to the workpiece feed station I (for removing or turning the workpiece). The transport device 5 has at least two—and in the illustrated embodiment exactly two—transport units 6, 7, each comprising a workpiece holder 6.1, 7.1. The workpiece holder 6.1, 7.1 is designed to mount—in particular to mount in clamped fashion—a workpiece fed from the workpiece feed station I. After the transfer from the workpiece feed station I, the workpiece is mounted in a clamping state by the workpiece holder 6.1, 7.1 and this clamping mounting is retained at least during the measurement of the workpiece at the measuring station II and the processing thereof at the processing station III in order to avoid an unintentional change in the position of the workpiece in space, in particular in the period between the measurement of the workpiece and its processing. Preferably, the clamping mounting is only released again at the workpiece feed station I in order to remove or turn the processed workpiece.

The transport device 5 has a guide rail arrangement 8, which allows the transport units 6, 7 to be moved in the y-direction, i.e. a movement transverse, in particular perpendicular to the machine plane ME. The guide rail arrangement 8 can have e.g. several guide rails 8.1, which are provided parallel and spaced apart on a machine bed 10.

Travel rails 9a, 9b are provided on this guide rail arrangement 8. The guide rail arrangement 8 interacts with the travel rails 9a, 9b in such a way that they can be moved in the y-direction. One transport unit 6, 7 each is provided on the travel rails 9a, 9b, namely the first transport unit 6 on a first travel rail 9a and the second transport unit 7 on a second travel rail 9b. The travel rails 9a, 9b can be moved independently of each other on the guide rail arrangement 8. In particular, a linear drive can be used to drive the travel rails 9a, 9b.

The transport units 6, 7, in turn, are guided independently of one another on the respective travel rails 9a, 9b, namely along the longitudinal axis of the travel rails 9a, 9b, i.e. in the embodiment shown in the x-direction. By moving the travel rails 9a, 9b on the guide rail arrangement 8 and moving the transport units 6, 7 on or along the travel rails 9a, 9b, the transport units 6, 7 can be moved in a horizontally aligned plane (x-y plane).

As described above, at least the measuring plane in which the workpiece is measured at measuring station II and the processing plane in which the workpiece is processed at processing station III lie in a common machine plane ME. This would make it possible in principle that, after measuring it at the measuring station II, a workpiece held on a transport unit 6, 7 is transported by mere movement in the x-direction to processing station III where it is processed without movement in the y-direction. In the illustrated embodiment, at least one, preferably both, transport units 6, 7 are also moved in the y-direction to allow the transport units 6, 7 to move past one another.

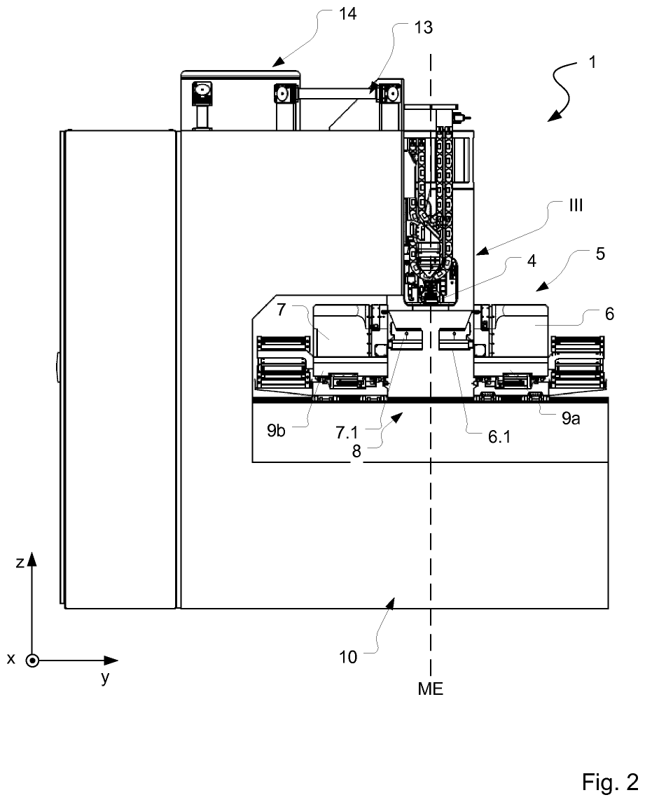

As can be seen in particular in FIG. 2, the transport units 6, 7 with their workpiece holders 6.1, 7.1 are arranged opposite one another, i.e. the workpiece holder 6.1 of the first transport unit 6 is located in the direction of the rear side of the machine (positive y-direction) and the workpiece holder 7.1 of the second transport unit 7 is located in the direction of the front side of the machine (negative y-direction). In a machine condition in which the first transport unit 6 is, for example, disposed at the measuring station II in order to measure the workpiece held thereon and the second transport unit 7 is, for example, disposed at the processing station III in order to process the workpiece held thereon, at least sections of the transport units 6, 7, in particular their workpiece holders 6.1, 7.1, come to lie in the common machine plane ME. In other words, at least partial sections of the transport units 6, 7 overlap, so that a movement of the first transport unit 6 from the measuring station II to the processing station III and a simultaneous movement of the second transport unit 7 from the processing station III in the direction of the workpiece feed station I is not possible in collision-free fashion without moving the transport units 6, 7 relative to one another in the y-direction.

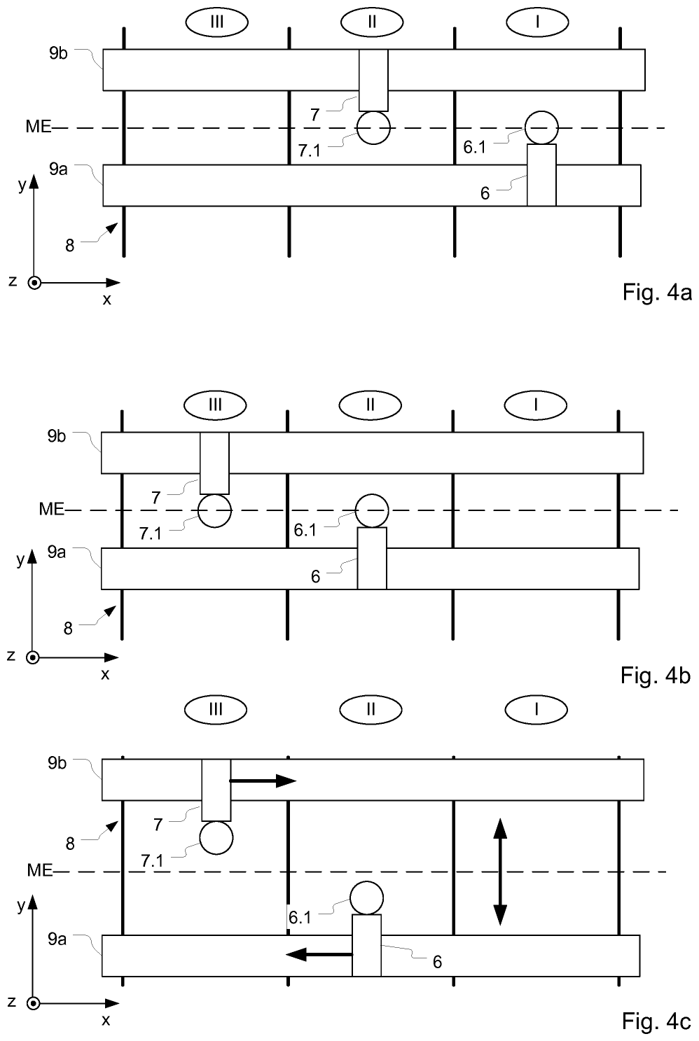

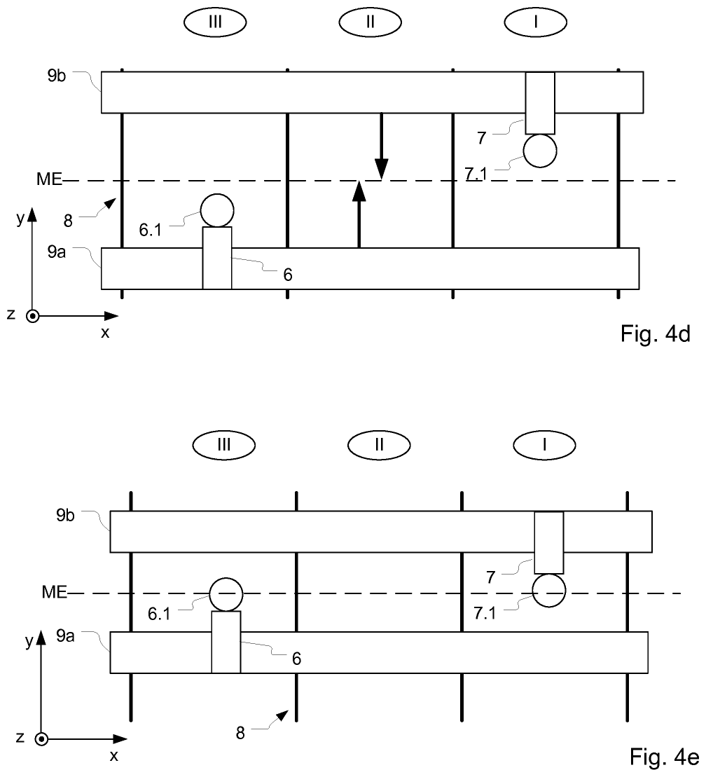

In the following, an example of a movement cycle of the transport device 5 based on the schematic FIGS. 4a to 4e is described in more detail. These figures only show the essential components of the transport device 5 along the individual stations I to III, namely the guide rail arrangement 8, the travel rails 9a, 9b and the transport units 6, 7.

In FIG. 4a, the first transport unit 6 is located at the workpiece feed station I in order to provide it with a workpiece to be processed. The second transport unit 7 is located at the measuring station II in order to measure a workpiece held by it. The travel rails 9a, 9b are positioned in the y-direction in such a way that the workpiece holders 6.1, 7.1 are arranged at the same height when viewed in the y-direction.

After feeding the workpiece to the first transport unit 6, it gets e.g. in line for measurement at the measuring station II and waits until the second transport unit 7 is moved from the measuring station II to the processing station III. When the second transport unit 7 has been moved out of measuring station II, the first transport unit 6 is moved to the measuring station II in order to measure the previously fed workpiece (FIG. 4b).

As shown in FIG. 4c, the travel rails 9a, 9b are then moved apart relative to each other in the y-direction (indicated by a double arrow) so that the distance between the travel rails 9a, 9b is increased. This can be done by moving only one of the two travel rails 9a, 9b or both. After moving apart, the transport units 6, 7 are moved in opposite directions (indicated by arrows running in the x-direction) and are moved past each other.

When the transport units 6, 7 have moved past each other, the distance between the travel rails 9a, 9b is reduced again, i.e. the travel rails 9a, 9b are moved towards each other as indicated by the arrows running in the opposite direction in FIG. 4d. It is here possible to only move one of the two travel rails 9a, 9b or both.

FIG. 4e shows the position of the travel rails 9a, 9b in their starting position so that the workpiece held on transport unit 6 can be processed at the processing station III and the workpiece held on transport unit 7 can be removed or turned at workpiece feed station I.

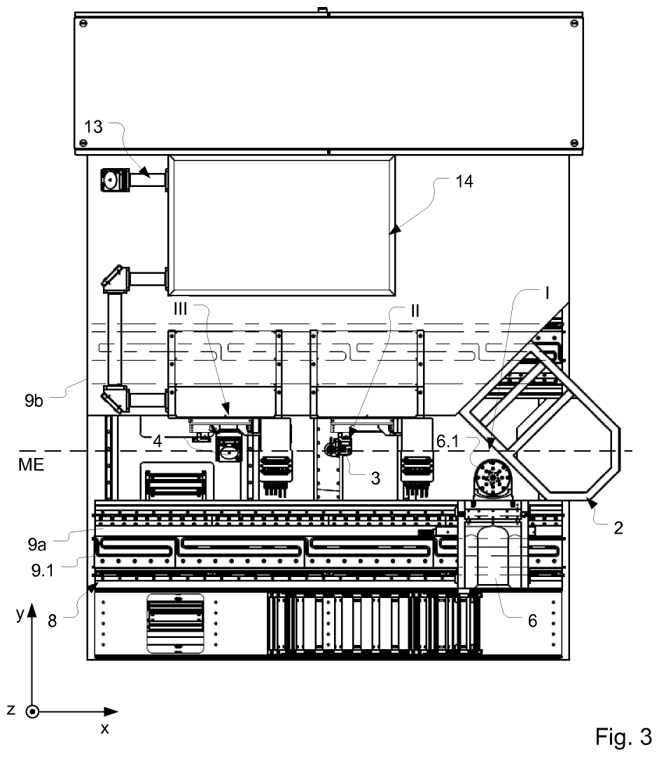

In order to achieve a high travel accuracy of the transport device 5 and a highly accurate reproducibility of the movement sequences, the transport device 5 is at least partially temperature-stabilized. In particular, temperature stabilization can be achieved by fluid cooling, especially water cooling. As can be seen in particular in FIG. 3, the travel rails 9a, 9b can have lines 9.1 which are laid in a serpent and in which the fluid effecting temperature stabilization is guided. Furthermore, the guide rail arrangement 8, the drives of the travel rails 9a, 9b or the transport units 6, 7 and/or the bearing elements of these units can also be temperature-stabilized. Thus, errors or deviations resulting from thermal expansion can be significantly reduced or avoided. In addition, the machine bed 10 can at least partially be made of a high mass material, such as stone, in particular granite, in order to increase the processing accuracy of the laser processing machine 1.

The workpiece holders 6.1, 7.1 can be rotatably adjustable in addition to their translational movability in x-y direction. In particular, the workpiece holders 6.1, 7.1 can each be rotated about two mutually independent spatial axes, in particular a first spatial axis running in the y-direction and a second spatial axis running transversely, in particular perpendicularly to the first spatial axis (running in an x-z plane). This means that the workpiece can be turned or swiveled at the respective station in a suitable manner, for example to be able to drill an inclined hole in the workpiece.

The units provided at the individual stations I to III, for example the workpiece changing unit 11 provided at the workpiece feed station I, or parts thereof, the sensor 3 at the measuring station II and the laser processing tool 4 at the processing station III, can be movable in the z-direction in order to be able to position the respective units at the required height for the processing step performed by them.

The laser radiation provided on the laser processing tool 4 is provided by a laser unit 12. This laser unit 12 is provided or integrated e.g. in the machine bed 10 of the laser processing machine 1. The laser unit 12 can be a short pulse laser (pulse duration less than 100 ns) or an ultra-short pulse laser (pulse duration less than 1 ps). Such a laser unit 12 can be used for high-precision processing of the workpiece, in particular by sublimation of the material to be removed. This sublimation can take place, for example, under the influence of a process gas, such as argon or nitrogen, by means of which the evaporated material is expelled.

The laser radiation provided by the laser unit 12 is fed to the laser processing tool 4 by a suitable beam guide 13. In beam guide 13, an optical system 14 can be provided for setting the laser radiation in a wobbling motion. This optical system can be formed by a cylindrical lens telescope, a wedge plate optical system or a scanner optical system with several mirrors, for example. Due to the wobbling movement of the laser beam it is possible to provide the workpiece with holes or recesses which have a positive or negative conical shape (cone opens against the laser beam direction or in the laser beam direction).

Preferably, a circularly polarized laser radiation is provided by the laser unit 12. Circular polarization ensures that material processing by means of the laser beam does not have a preferred direction in which the material is removed faster than in another spatial direction. This results in the same or essentially the same material removal per time unit in the x and y directions.

It is understood that numerous changes and modifications are possible without abandoning the inventive concept on which the invention is based. For example, the laser processing machine 1 may only consist of two stations, the first station being a processing station with a laser processing tool and the second station being designed as a measuring station and/or as a further processing station. The components can then be fed at the second station, for example. The transport device is designed to move transport units between these stations.

### LIST OF REFERENCE SIGNS

1 laser processing machine
2 workpiece feed unit
3 sensor
4 laser processing tool
5 transport device
6 first transport unit
6.1 workpiece holder
7 second transport unit
7.1 workpiece holder
8 guide rail arrangement
8.1 guide rail
9a first travel rail
9b second travel rail
9.1 line
10 machine bed
workpiece changing unit
11 laser unit
12 beam guide
13 optical system
14 ME machine plane
x x-direction
y y-direction
z z-direction
I third station
II second station
III first station

1. A laser processing machine for removing material from a workpiece, comprising at least a first station at which a laser processing tool is provided and at which the workpiece is processed by means of the laser processing tool, at least a second station at which the workpiece is measured and/or processed, and a transport device for moving the workpiece between the first station and the second station, the transport device having at least two transport units, which can be moved independently of one another in two different spatial directions (x, y) in such a way that the transport units can be moved past one another in a first spatial direction (x) along which the first and second stations are arranged.

2. The laser processing machine according to claim 1, wherein the transport device has a guide rail arrangement which runs in a second spatial direction (y) and in that at least two travel rails which can be moved independently of one another are provided on this guide rail arrangement.

3. The laser processing machine according to claim 2, wherein exactly one transport unit is guided on each travel rail and is movable in the first spatial direction (x) running transversely to the second spatial direction (y).

4. The laser processing machine according to claim 2, wherein the movement of the travel rails on the guide rail arrangement and/or the movement of the transport unit on the respective travel rail is effected by means of a linear direct drive.

5. The laser processing machine according to claim 2, wherein the first and second stations are arranged in a common, vertically aligned machine plane and in that the laser processing machine is designed in such a way that at least one travel rail for moving the transport units past one another is moved along a second spatial direction (y) running transversely to the machine plane.

6. The laser processing machine according to claim 5, wherein a travel rail or at least two travel rails are moved along the second spatial direction (y).

7. The laser processing machine according to claim 5, wherein the at least one travel rail is moved back along the second spatial direction (y) after the transport units have moved past one another.

8. The laser processing machine according to claim 2, wherein the guide rail arrangement and/or the travel rails are temperature-stabilized.

9. The laser processing machine according to claim 2, wherein the drives for adjusting the travel rails and/or the drives for adjusting the transport units are temperature-stabilized.

10. The laser processing machine according to claim 1, wherein each transport unit has a workpiece holder, which can be rotated and/or swiveled about at least two spatial axes orthogonal to one another.

11. The laser processing machine according to claim 2, wherein each of the transport units has a workpiece holder and in that the transport units provided on different travel rails are arranged in such a way that the workpiece holders protrude from the respective travel rail on different sides.

12. The laser processing machine according to claim 1, wherein a third station designed as a workpiece feed station is provided.

13. The laser processing machine according to claim 12, wherein the second station is provided between the first station and the third station.

14. The laser processing machine according to claim 1, wherein the first and second stations are arranged in such a way that the workpiece is processed after moving it in the first spatial direction (x) without a movement in a second spatial direction (y) running transversely to the first spatial direction (x).

15. The laser processing machine according to claim 1, wherein a first transport unit is moved from the first station to the second station and a second transport unit is moved in the opposite direction from the second station to the first station, when moving them past one another.

16. The laser processing machine according to claim 1, wherein the second station is a measuring station with a sensor for recording workpiece information, and in that the workpiece is processed at the first station on the basis of the workpiece information.

17. A method for operating a laser processing machine, comprising at least a first station with a laser processing tool, a second station, and a transport device having at least two transport units for moving workpieces between the first and second stations, the method comprising the steps of:
carrying out a processing step on a workpiece held on a first transport unit at the first station;
carrying out a measuring step and/or processing step on a workpiece held on a second transport unit at the second station;
moving the second transport unit past the first transport unit in such a way that the transport units are moved apart in a second spatial direction (y) transverse to a machine plane, in which the first and second stations are arranged, and are moved parallel to this machine plane in order to position the first transport unit at the second station and/or the second transport unit at the first station.
